(19) United States
(12) Patent Application Publication
(10) Pub. No.: US 2005/0052798 A1
(43) Pub. Date: Mar. 10, 2005

(54) Solid state ac switch

(76) Inventor: Massimo Grisoni, Lugano (CH)

Correspondence Address: SHOEMAKER AND MATTARE, LTD, 10 POST OFFICE ROAD - SUITE 110, SILVER SPRING, MD, 20910, US

(21) Appl. No.: 10/499,651

(22) PCT Filed: Jan. 14, 2003
(86) PCT No.: PCT/IT03/00010

(30) Foreign Application Priority Data
Jan. 15, 2002 (IT) BS2002A000002

(51) Int. Cl. H02H 3/00

(52) U.S. Cl. 361/42

(57) ABSTRACT

The present invention relates to an electronic switch for AC currents realised only with solid state components and comprising a main bipolar or unipolar switch circuit to switch the ac current from ac line to a load, at least a current limit circuit, a current measurement circuit, a current range setting circuit, a masimum current setting circuit, and a temperature control circuit, all these circuits being controlled by a control logic circuit intended mainly to open and close the switch circuit by means of a manual command and/or according to signals from said circuits.

### FIELD OF THE INVENTION

The present invention refers to a solid state ac switch for controlling the current flowing into a load and the leakage currents of the ac line, with the capability to detect overcurrents caused by a dead short or abnormal current caused by any failure and breaking alternating currents, actionable by a local manual pushbutton or by a remote signal interface, realised with reduced dimensions, weights and costs compared to an actual electromechanical device, and intended to be used in any applications where there is the need to replace mechanical power control switches with the solid state switches in order to achieve long life, quiet operation and installation controls for a complete safe operation of the plant.

### STATE OF THE ART

Actually the ac voltages are controlled by electromechanical breakers or electronic devices also called Solid State relays, hereinafter SSR. The electromechanical breakers do not offer a protection to the load and to the line and an information about the state of the ac line or the current flowing into the load; these performances are reached only if these devices are used jointly with other units based on thermal or magnetic principles, but always mechanical devices, or with normal fuses, anyway devices that in a plant must be added to the main breaker increasing dimensions, costs, wiring and complexity.

Then, all these electromechanical devices have anyway a long and not constant operating time caused by the mechanical construction of the opening/closing mechanism of the contacts and are subjected to a derating performance, life dependent, specially if installed in a plant with presence of high noises for the temperature, humidity and vibrations. Furthermore, due to the increasing presence inside the electrical boxes of others electronic devices, it has become an increasingly common requirement to reduce the electromagnetic noise that appears during opening/closing of mechanical contacts.

Furthermore, the use of SSR switches, as far is concerning the electromechanical noise, is very critical because they have a high noise factor, and also the SSR do not warrant a better protection of the load against over currents because they operate slowly in case of short circuit failure or overcurrents detection. The SSR, again, can not be used in an electrical installation for monitoring the load efficiency or current flow if not properly connected to an external and added electronics.

### OBJECTS OF THE INVENTION

The present invention relates to solid state switching apparatus that can solve all the problems of the mechanical construction of actual breakers, specially if used in hard environments.

The switch of the invention can control the load and the ac line in any electrical installation where the actual breakers does not satisfy the requirements or must be used jointly with other devices or electronics parts.

With advances in solid state power switching technology, these problems can be now solved and the present invention relates to a practical approach of the problem presenting a solid state switch for alternating currents that can substitute the actual electromechanical devices and SSR with advantages.

A first object of the present invention is to provide a solid state switch, without any mechanical parts, applicable to an alternating voltage that can easily and with convenience substitute the functions performed by the electromechanical devices and SSR.

Another object of the invention is to provide a solid state switch for alternating currents that can be activated manually and/or by a remote command without the use of such mechanisms for the opening/closing operations.

Still another object of the invention is to provide a solid state switch for alternating currents that can measure the currents flowing into the load.

Still another object of the invention is to provide a solid state switch for alternating currents that can manage abnormal currents, overcurrent and dead short or short circuits currents for an indeterminate time without problems.

Still another object of the invention is to provide a solid state switch for alternating currents with high immunity to external environmental factors and not generating electromagnetic noise by itself.

Still another object of the present invention is to provide a solid state switch for alternating currents with weights, dimensions and costs reduced if compared with a traditional electromechanical devices.

Still another object of the present invention is to provide a solid state switch for alternating currents that can present to the user, by means of lamps, an indication of its state.

Still another object of the present invention is to provide a solid state switch for alternating currents that can increase the safety in an installation, reduce maintenance and positively influence the costs of maintenance.

According to the present invention, these objects are achieved with a solid state ac switch for alternating currents made only with solid state components, controlled by an electronic circuit, and realised with special solutions for safety and protections required for a safe use with alternating currents.

### BRIEF DESCRIPTION OF THE DRAWINGS

FIG. 1 is a block diagram of a solid state ac switch as here presented;

FIG. 2 is a schematic view of the main switch circuit;

FIG. 3 shows, in top view, an example of the main circuit switch of FIG. 2;

FIG. 4 shows, in side view, the main circuit switch of FIG. 3; and

FIG. 5 shows a schematic circuit for the measurement of the ac line leakage current.

### DESCRIPTION OF THE INVENTION

The solid state ac switch for alternating currents hereinafter described can be used with advantages in many applications.

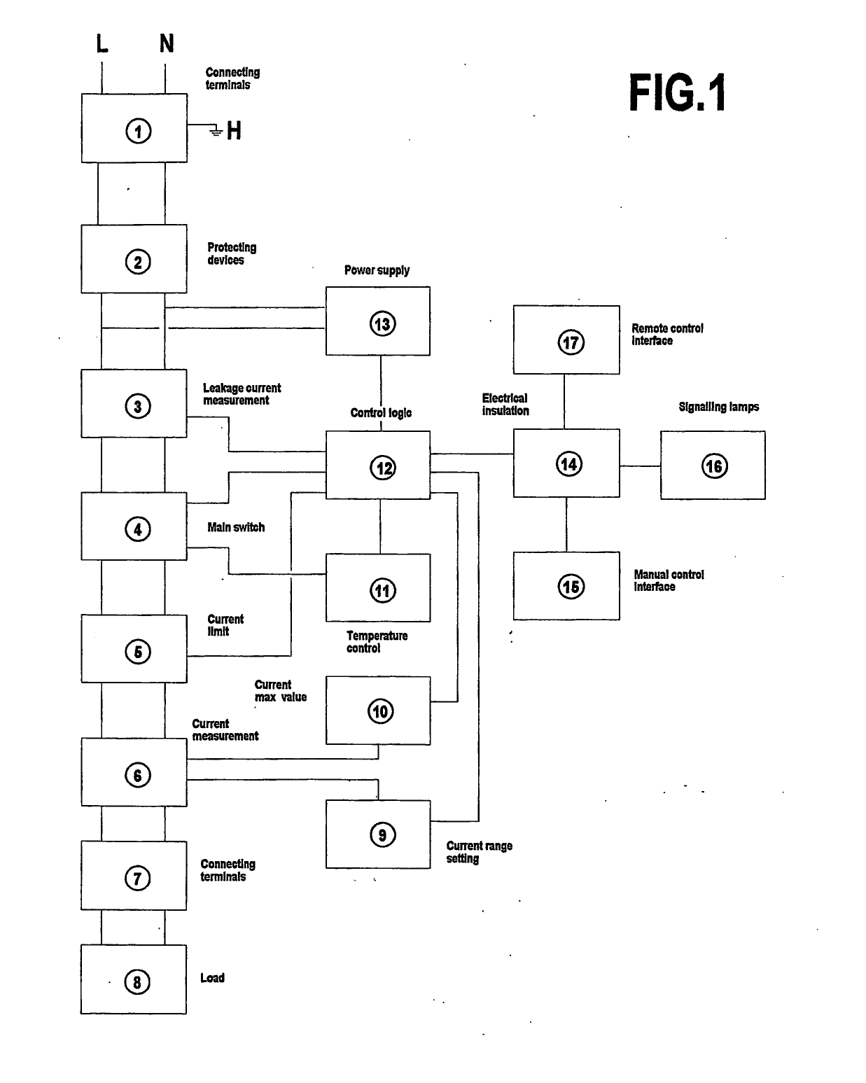

The block diagram of FIG. 1 shows generically an application on an electrical alternating single phase line to power a load 8 in which all the two as lines L (Line) and N (Neutral) are controlled by a circuit switch 4 equally realised for the two ac lines L and N but in case applicable also to a single line.

With reference to FIG. 1, the conductors of said ac lines L and N and the electrical ground line H (Heart) are connected to the solid state ac switch by means of proper connecting terminals 1, 7, specially designed for this application to be resistant to vibrations and temperatures stresses.

The solid state ac switch itself and the load are protected by an usual and opportune protecting device 2.

Connected to the ac lines L and N, can be inserted a circuit for measuring the leakage current 3 as the difference of the current flowing in the said lines.

The main switch circuit 4 is the most important part of the ac solid state switch; it's realised by using power FET's transistors 18 fixed on an appropriate heatsink 20 necessary to waste the heat generate in abnormal conditions.

The load 8 is controlled by a current limit circuit 5 and by a current measurement circuit 6; the current measurement circuit 6 is connected to a circuit for current range setting 9 used to select different ranges of currents in a same solid state ac switch.

The switch also includes a temperature control circuit 11 designed to protect the main switch circuit 4 to halt the current flow in case of abnormal rising in temperature.

The circuits 3, 5, 9, 10 and 1 1 are connected to a control logic circuit 12 intended mainly to open and close the load 8 by driving directly the transistors 18 of the main switch circuit 4, on request of a command from the user and/or according to signals from circuits 3, 5, 9, 10 and 11.

Resuming, the control logic circuit 12 has the following functions:
maximum allowable leakage current control,
limit current signal control,
current range setting control,
maximum current control,
heatsink maximum temperature control,
interface signal control,
opening/closing of the circuit switch 4.

All the functions of the control logic circuit 12 can be achieved with analog devices in which the values, for example, of the timers or of the current threshold or voltages references are obtained with capacitor or precision resistances; the same functions should also be obtained with the use of a more flexible and programmable microcontroller in which all the parameters like threshold, timers, settings and others more complex functions should easy better implemented and programmed or modified. The main switch circuit 4 can be manually operated or can be under the control of an electrical signal.

For this purpose, the ac solid state switch, as explained in this application, is provided with a manual control interface circuit 15 provided with a pushbutton to activate and deactivate the load and with a remote control interface circuit 17 designed to control the ac solid state switch functions by means of an on/off command line and others signal lines.

The ac solid state switch is provided of signalling lamps circuit 16 provided with lamps to be used to inform about the device functionality. Particularly it's expected that the lamps indicates the connection of the switch to the ac line, the opening/closing or halt state if eventually occurred in protection mode.

The lamps can be illuminated in a fixed or blinking mode when abnormal conditions are detected.

The interface circuits 15 and 17 and the signalling circuit 16 are electrically separated from others circuits connected to the ac voltages by an electrical insulation circuit 14 made of optoisolators.

The ac solid state switch is completed with a low voltage power supply circuit 13 for powering with three separate output do voltages all the internal circuits. Of three do low voltages, one of them is used exclusively for power the control logic 12, the second for the circuits related to the L ac line and the third to the N ac line.

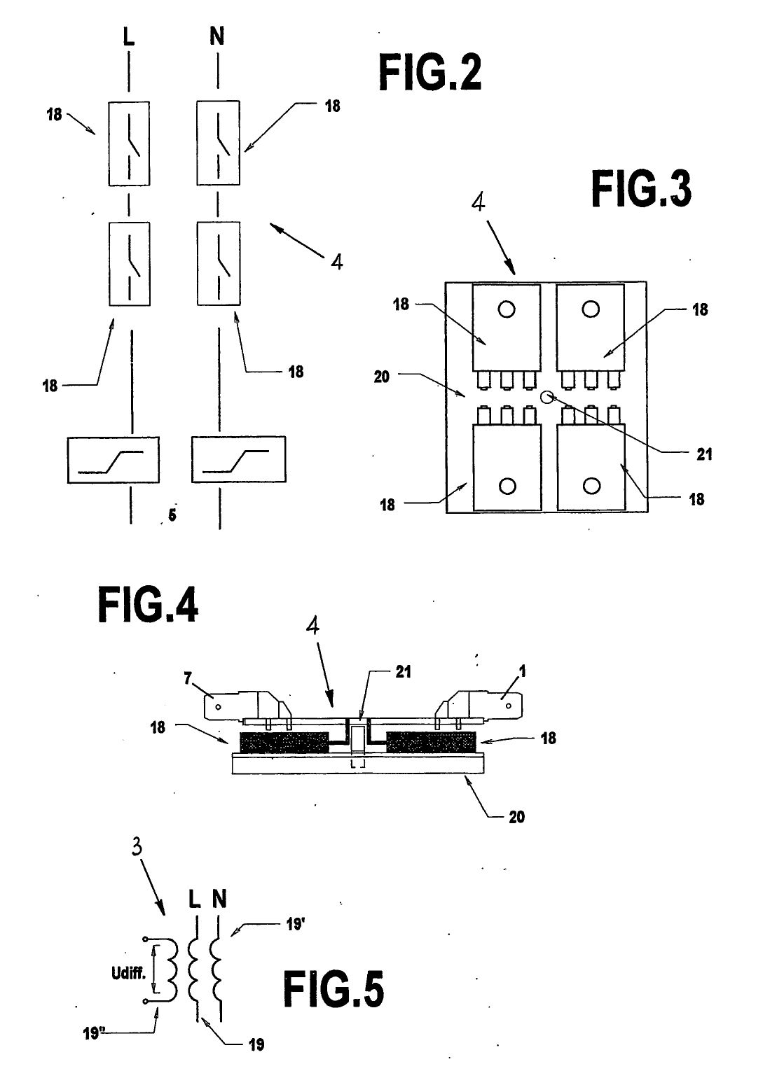

For a deeper knowledge of the invention, FIGS. 2, 3 and 4 relating to the main switch circuit 4 have now to be referred to.

One of the solid state switching components most adaptable for alternating currents applications is the power field effect transistor (FET). Two unidirectional low costs power FET's 18 forms the main switch circuit 4 and are fixed on the heatsink 20.

On each ac lines L and N, the main switch 4 consists of two power FET's transistors 18 connected in series in a back to back configuration. These transistors 18 have a similar arrangement to avoid that different temperature steps, subsequent to the wasted power during protection phase and less in normal operation, can produce problem to the ac solid state switch. For this purpose, the transistors 18 are fixed on the heatsink 20; the main function of this heatsink is to collect and quickly and equally distribute as far is possible on the whole volume the heat quantity as integrator of the heat wasted by the transistors 18 in the worst case of short circuit current. This heatsink is made of a block of hard metal with strong thermal conductivity to quickly accumulate into its volume the heat generated by the transistors 18, protecting them particularly when overcurrent or current short circuits or high gradient temperature are present.

Inserted inside the heatsink 20 there is a temperature sensor 21 as protecting device of circuits against extreme working temperatures; the control logic circuit 12 monitors the temperature of the heatsink 20 to preserve the internal power FET's junction temperature opening definitely the main switch circuit 4.

The heatsink time constant is dependent from the power FET's transistors 18 thermal characteristics, from the setup time of the temperature sensor 11, and from the speed of the control logic circuit 12. The choice of the two power FET's transistors 18 in the main switch circuit 4 has been selected for the good voltage blocking capability for both polarity of the supplied alternating current, one power FET providing blocking during half cycle of one polarity and the other power FET providing blocking during half cycle of the opposite polarity. Then the blocking capability of the power FET's has been also improved by the use of a very simple and quick circuitry for detection of limit current 5 and with the design to activate the load on zero crossing of the alternating current then verifying any malfunction when the voltages are again relatively low.

The limit circuit 5 is capable of detecting easily and speedily like overcurrent caused by a dead short or abnormal currents caused by short circuit failure or momentary resistance short circuit.

The combination of the performances of the power FET's transistors 18 types, the current limit circuit 5 design and the heatsink 20 design allow to realise a very resistant solid state ac switch with an high and safe breaking capability.

The worst case of a dead or short circuit should appears with causality at the top of cycle when the voltages reaches the maximum value Vₚₚ; anyway, also this case is recovered after few microseconds by the control logic circuit 12.

The closing of the main switch circuit 4 is always active and only at the zero point of the cycle in order to test the subsequent eventual abnormal current at lower voltages of about 6-8 Vₘₛ. This solution reduce the power wasted on the heatsink and also permits a permanent short circuit condition for an indeterminate time.

The limit current circuit 5 is signalling to the control logic circuit 12 any current flow that overcomes the values settled in the current maximum value circuit 10 designed as a current source circuit with the values defined by the characteristics of the power FET's transistors 18 used and realised with a simple shunt resistance.

In particular, when the signal from limit current 5 is activated, a first timer located inside the logic circuit 12 starts its count down and still allows the flowing of an overcurrent or also of a short circuit current across the transistors 18, until its reset, for a very short time, in any case in the order of few microseconds; this time anyway shorter than the time supported by the transistors 18 in a similar critical situation of short circuit current state. A second timer, located again in the logic circuit 12, starts its count with the first; for all this second time the logic circuit 12 activates the main switch 4 and the first timer.

When the second timer is resetted, it sends to the main switch circuit 4 the command to open definitely the ac lines from the load 8.

This control allows both to insert loads that can require higher initial current spikes and to manage with better results the short circuit currents to safe load and line.

The current measurement circuit 6 is a separate circuit realised with a comparator and a pulse modulation design; the current value Iₘₛ measured by the current measurement circuit 6 is compared with a precision reference voltage in the current range circuit 9.

FIG. 5 discloses a principle of construction of the leakage current measurement circuit 3. The latter measures the leakage of the current of the ac lines L and N detecting the current difference flowing across these conductors using three coils 19, 19′ and 19″ combined and assembled on a separate circuit that also optionally can be inserted inside the solid state ac switch.

Particularly, if the voltage induced U_{diff,} measured on the coils 19″ is greater than a maximum value U_{diff MAX} (depending on the characteristics of the installation) the loss of current of one of the ac lines L or N is too much and the main switch circuit 4 is opened by a proper command from control logic circuit 12.

Using the remote control interface circuit 17, this ac solid state switch can be activated by an external signal but others signal of the circuit 17 can be used to know the following functions:
the current flow,
overcurrent state,
leakage current state,
higher temperature state,
malfunction state.

### APPLICATION EXAMPLES

Some of the characteristics of this solid state ac switch can be better illustrated with the following application examples.

Considering this solid state ac switch connected to the ac electrical lines by means of the connecting terminals 1 to a load 8 and to an external system with the remote control interface circuit 17, with this configuration we have the possibility to control the load and the ac line. The circuit 17 has a certain number of interface lines by means of them it's possible to command the opening/closing of the solid state ac switch and to control its functions and the ac line current leakage from the connecting terminals 7 to the load 8.

The following example suggest a way to control the functions of the switch demonstrating with evidence the innovation herein described.

When the external system sends the command to activate the load 8, at the same time it can verify if the ac line does not have current leakage, measured by the leakage current circuit 3 and transferred on a signal of the remote control interface circuit 17.

This characteristic allows to know the ac line state at every activation command and during all the activation time of the load 8 and allows too to inform the operators what ac electrical line inside the plant has problems for a quick and safe maintenance.

This capability is very important if this solid state ac switch is installed in a complex plant and exposed to a severe environmental conditions and subject to a safety rules as the marine electrical installation require, as matter this switch has been studied to be applied first to this kind of installations.

It has to be note that, if a leakage on the ac lines is detected also without an external system, when the operator acts on the pushbutton to activate the switch, the signalling lamp starts blinking and the load is immediately disconnected.

A second example illustrate the way a load can be activated.

As described, the current measurement circuit 6 allows to know at every moment the current value I_{eff} flowing across the load; this current is compared with the current range selected in the circuit 9 and the maximum allowable value as defined for the circuit 10.

If the load is an incandescent lamp, wherein, as well known, its resistance is like a short circuit when cool, the circuit 5 activates the over current procedure signalling to the control logic circuit 12 to open the main switch circuit 4 until the current is over the threshold set for the circuit 9 and 10 in order to safe the transistors 18 and the load 8 from initial current inrush. The control logic circuit 12 anyway sends a pulse modified command, for a certain time, to the main switch circuit 4 in order to let flow a pulsed current till the load resistance increase or the current reaches its nominal value; after a certain time, anyway, the main switch 4 should open to put in a safe condition the load and the line.

1. Electronic switch for ac currents realised only with solid state components and characterised in that it comprises a main bipolar or unipolar switch circuit (4) to switch the ac current from ac line to a load (8), at least a current limit circuit (5), a current measurement circuit (6), a current range setting circuit (9), a maximum current setting circuit (10), and a temperature control circuit (11), all these circuits being controlled by a control logic circuit (12) intended mainly to open and close the switch circuit (4) by means of a manual command and/or according to signals from said circuits (5,9,10,11).

2. Electronic switch according to claim 1, wherein the main switch circuit (4) includes at least a couple of power FET's transistors (18) for each ac line, said couple of transistors (18) being fixed on a hard metal heatsink (20) with high thermal conductivity or vented and provided with a temperature sensor (21) inserted therein and connected to the temperature control circuit (11).

3. Electronic switch according to claim 1 or 2, characterised in that it also comprises, connected to the ac lines (L and N), a circuit (3) for measuring the leakage current as the difference of the current flowing in the said lines, said circuit including a coil 19 and 19′ on each ac line conductors and a separate coil 19″ in which the inducted voltage is proportional to the current difference between the L and N lines.

4. Electronic switch according to one of the previous claims, wherein the control logic (12) acts with an high speed circuitry to open the main switch circuit (4) with a first timeout, in case of a signal from the current limit circuit (5); the control logic (12) opens the main switch circuit (4) and then closes it to resume the control of circuits signals (5, 9, 10 and 11), this sequence being repeated until normal conditions are reached inside the circuits (5) and (11) according to the parameters fixed in the circuits (9) and (10) or definitely suspended after a second timeout.

5. Electronic switch according to one of the previous claims, further comprising a manual control interface circuit (15) and a remote control circuit (17), said circuits being connected to the control logic circuit (12) with the interposition of an electrical insulation circuit (14) made of optoisolators devices.

6. Electronic switch according to one of the previous claims, further comprising a signalling lamps circuit (16) connected to the control logic circuit (12), said signalling circuit being provided with at least two lamps that combined and blinking or with continous lights give information about the ac solid state switch connected to the ac line, activated, deactivated, or halted if protections operate or errors occur.

7. Electronic switch according to one of the previous claims, further comprising a low do voltage power supply circuit (13) provided with one or more outputs electrically insulated from the as line, one of them used for powering the control logic circuit (12) and the others to power remaining circuits related to the alternating voltages of the lines L and N.
